(19) United States
(12) Patent Application Publication
(10) Pub. No.: US 2004/0047655 A1
(43) Pub. Date: Mar. 11, 2004

(54) System for supplying high-density developing solution in image forming apparatus

(75) Inventors: Kwang-Ho No, Suwon-City (KR); In-Yong Song, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/459,445

(22) Filed: Jun. 12, 2003

(30) Foreign Application Priority Data
Sep. 9, 2002 (KR) 2002-54352

(51) Int. Cl. G03G 15/10

(52) U.S. Cl. 399/238

(57) ABSTRACT

A system for supplying a high density developing solution in an image forming apparatus includes ink cartridges each containing corresponding high density developing solutions having respective colors, a cartridge unit recognizing colors of the ink cartridges and supplying the high density developing solutions, developing devices developing an image using the high density developing solutions supplied by the cartridge unit, and connecting units respectively connecting the developing devices to the cartridge unit and transferring the high density developing solutions to the developing devices therethrough, wherein the high density developing solutions inside the ink cartridges are supplied directly to the developing devices through the cartridge unit and the connecting units, respectively. The image forming apparatus can be manufactured in a compact size at a low price.

### CROSS-REFERENCE TO RELATED APPLICATIONS

This application claims the benefit of Korean Patent Application No. 2002-54352, filed Sep. 9, 2002, in the Korean Intellectual Property Office, the disclosure of which is incorporated herein by reference.

### BACKGROUND OF THE INVENTION

1. Field of the Invention

The present invention relates to a system for supplying a high-density developing solution, and more particularly, to a system for supplying a high-density developing solution from an ink cartridge directly to a developing device in a liquid color image forming apparatus.

2. Description of the Related Art

A conventional image forming apparatus using a developing solution has an advantage in obtaining high quality images by developing electrostatic latent images using the developing solution with particles having a diameter from about 0.5 μm to about 5 μm.

A conventional inkjet image forming apparatus obtains a proper intensity of an image by using a low-density developing solution with an ink density lower than or equal to 3%.

As shown in FIG. 1, a system for supplying developing solutions of a conventional inkjet color image forming apparatus is provided with ink cartridges 12, a cartridge unit 14, norpar tanks 16, ink tanks 18, working solution units 20 and developing devices 22.

The cartridge unit 14 distinguishes colors of ink from one another and then transfers high-density ink (developing solution) contained in the ink cartridges 12 to the ink tanks 18 according to each color, and the working solution unit 20 dilutes the high-density ink transferred to the ink tanks 18 with NORPAR, which is a solvent provided by EXXON Corporation, stored inside the norpar tanks 16 to low-density ink having the ink density lower than or equal to 3%. Thereafter, the working solution unit 20 transfers the diluted low-density ink to the developing devices 22, and then the developing devices 22 develop an electrostatic latent image using the diluted low-density ink.

The conventional system for supplying the developing solutions to the developing devices 22 requires complex devices to supply sufficient developing solutions to a developing region and to recover the ink density of the developing solutions.

Namely, the system is provided with the ink tanks 18 and the norpar tanks 16, and with the working solution unit 20 mixing solutions from the ink tanks 18 and the norpar tanks 16 to dilute the high-density ink to the low-density ink with the ink density lower than or equal to 3%.

After the diluted low-density ink is used for developing the electrostatic latent image, an amount of particles (ink density) inside the developing solution is changed, and thus a developing agent needs to be replenished. Therefore, a density regulating unit (not shown) has to be further provided, thereby causing complexity of construction and a large volume of the system, which may result in a high cost.

### SUMMARY OF THE INVENTION

An aspect of the invention is to solve at least the above and/or other problems and/or disadvantages and to provide at least the advantages described hereinafter.

Accordingly, another aspect of the present invention is to solve the foregoing problems by providing a system for providing a high-density developing solution in an inkjet color image forming apparatus, which supplies the high-density developing solution directly to a developing device, thereby capable of reducing a volume of the inkjet color image forming apparatus.

Another aspect of the present invention is to provide a system for supplying a high-density developing solution to a developing device in an image forming apparatus, which directly uses the high-density developing solution to minimize the number of elements required for manufacturing the image forming apparatus, thereby realizing a manufacturing cost reduction.

Additional aspects and advantages of the invention will be set forth in part in the description which follows and, in part, will be obvious from the description, or may be learned by practice of the invention.

The foregoing and/or other aspects and advantages are realized by providing a system for supplying a high density developing solution to a developing device in an image forming apparatus. The system includes ink cartridges each containing a high density developing solution for each color, a cartridge unit recognizing colors of the ink cartridges and supplying the high density developing solution, developing devices developing an image using the high density developing solutions supplied by the cartridge unit, and a connecting unit respectively connecting the developing devices to the ink cartridges and transferring the high density developing solutions to the developing devices therethrough, wherein the high density developing solutions contained inside the ink cartridges are supplied directly to the developing devices through the cartridge unit and the connecting units, respectively.

It is possible that the connecting unit may be a tube.

The system for supplying the high-density developing solution in the image forming apparatus may supply the high-density developing solution in the ink cartridges directly to the developing devices through the cartridge unit, thus the system may not need a device for regulating an ink density of the high-density developing solution, and the image forming apparatus may be manufactured in a compact size.

Further, the system for supplying the high-density developing solution in the image forming apparatus does not need additional devices for supplying a low-density developing solution shown in the related art, thereby enabling a cost reduction for manufacturing the image forming apparatus.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a view showing a system for supplying a developing solution to a developing device in a conventional image forming apparatus;

FIG. 2 is a view showing a system for supplying a high-density developing solution in an image forming apparatus according to an embodiment of the invention; and

FIG. 3 is a side cross-sectional view schematically showing a developing device of the system shown in FIG. 2.

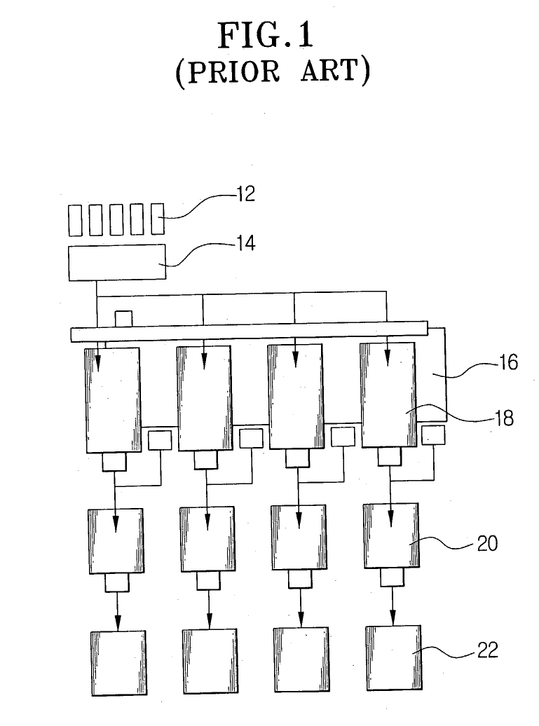

### DETAILED DESCRIPTION OF THE PREFERRED EMBODIMENT

Reference will now be made in detail to the present preferred embodiment of the present invention, examples of which are illustrated in the accompanying drawings, wherein like reference numerals refer to the like elements throughout. The embodiment is described in order to explain the present invention by referring to the figures.

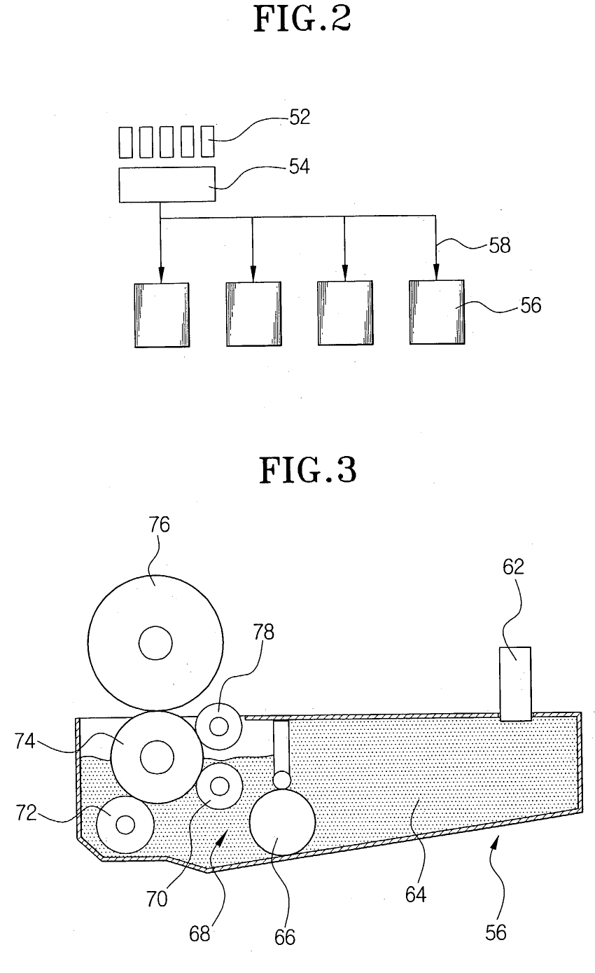

FIG. 2 is a view showing a system for supplying a high-density developing solution in an image forming apparatus in accordance with an embodiment of the invention.

The system for supplying a high-density developing solution includes ink cartridges 52, a cartridge unit 54, developing devices 56, and a connecting unit 58 connecting the cartridge unit 54 to the developing devices 56.

The ink cartridges 52 each containing high-density ink (developing solution) according to a plurality of colors, are inserted into the cartridge unit 54 with respect to the colors, and ink contained inside the ink cartridges 52 is transferred to the developing devices 56 through the connecting unit 59. The ink cartridges 52 are removed from the cartridge unit 54 of the system after being used up. The connecting unit 58 may be a tube.

For example, when a yellow ink cartridge 52 having high-density yellow ink is inserted into the ink cartridge unit 54 to supply the yellow ink to a yellow developing device 56, the cartridge unit 54 recognizes yellow color by a recognition unit disposed thereinside and supplies the yellow ink to a yellow developing machine of the developing devices 56 through the tube 58 connected thereto by using gravity. The ink cartridges 52 may supply a mixture of ink and compressed gas to the cartridge unit 54.

The system for supplying the high-density developing solution is not provided with a norpar tank transferring low-density ink to the developing devices 56, an ink tank containing ink nor a working solution unit to mix solutions therefrom to produce the low-density ink, which is provided in the related art. Instead, the image forming apparatus according to the invention is provided inside with the cartridge unit 54, the developing devices 56, and the tube 58 connecting the cartridge unit 54 and the developing devices 56, thereby enabling a compact size of the apparatus and a cost reduction.

FIG. 3 is a side cross-sectional view schematically showing one of the developing devices 56 of the system shown in FIG. 2.

According to the invention, the high-density developing solution can be directly supplied to the developing devices 56 owing to construction of the developing devices 56 as shown in FIG. 3.

Each of the developing devices 56 is divided into two rooms: an ink room 64 storing the high-density developing solution supplied from each of the ink cartridges 54 and a developing room 68 receiving a developing roller 74, etc. The ink room 64 is provided at an upper portion with an ink inlet 62 through which ink is injected thereto from the connecting units. The developing room 68 includes the developing roller 74, a deposit bar 70, a cleaning roller 72 and a metering roller 78.

The developing roller 74 is soaked in a developing solution up to about a half-length thereof and is disposed to have a predetermined developing nip with a photoconductor 76. The deposit bar 70 is soaked under the developing solution inside the developing device 56 and disposed to contact or to have a predetermined gap with the developing roller 74. The deposit bar 70 supplies the developing solution to be deposited onto the developing roller 74 by applying a force from a magnetic field generated by a voltage supplied from a power source (not shown).

To supply toner particles onto the developing roller, a bias voltage from 300V to 560V is applied to the developing roller 74, and a bias voltage from 500V to 1550V is applied to the deposit roller 70.

The metering roller 78 is in contact with the developing roller 74 and pushes the developing roller 74 with a predetermined pressure to arrange a thickness and a density of toner deposited on the developing roller 74. The cleaning roller 72, which is made of a sponge, is in contact with the developing roller 74 and rotates together to clean waste toner remaining on the developing roller 74.

The developing roller 74, which is a conductive elastomer, is made with polyurethane rubber or NRB and has a resistance from 10⁵ to 10⁸ ohm, a Shore A hardness from 25 to 26, and a surface roughness from Ra 1 to 4 μm. The developing roller 74 may sufficiently supply a developing solution to the developing nip as much as a conventional system for supplying a low-density developing solution supplies the low-density developing solution to a conventional developing device.

An amount of the toner particles deposited on the developing roller 74 varies according to an electrostatic force. When the high-density ink with the ink density from about 3% to 12% is used, ink (toner) formed on the developing roller 74 normally has the ink density from 6% to 14% with a thickness from 400 μg/cm² to 1100 μg/cm² before the high-density ink is deposited on the deposit bar 70 and pressured by the metering roller 78.

Thereafter, the metering roller 78 makes the thickness of the toner on the developing roller 74 uniform to obtain a uniform intensity of an image formed on a paper. Using the metering roller 78, the uniform thickness of the toner from about 220 μg/cm² to 270 μg/cm² may be obtained on the developing roller 74. The developing device further includes an ink supplying roller 66 supplying the high-density ink contained in the ink room 64 to the developing room 68.

With the developing device of the above construction, the system for supplying the high-density developing solution in the image forming apparatus according to the invention may supply the high-density developing solution directly to the developing device and may be constructed only by internally installing the cartridge unit and developing device, so that a satisfactory result can be obtained from a printed image without soiling a non-printed part by using the high-density developing solution with the ink density from 3% to 40%.

While the invention has been shown and described with reference to certain preferred embodiments thereof,. it will be understood by those skilled in the art that various changes in form and details may be made therein without departing from the spirit and scope of the invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A system for supplying a developing solution in an image forming apparatus, the system comprising:
ink cartridges each containing a corresponding one of high density developing solutions having respective colors;
a cartridge unit recognizing the colors of the ink cartridges and supplying the high density developing solutions;
developing devices developing an image using the high density developing solutions supplied by the cartridge unit; and
connecting units respectively connecting the developing devices to the cartridge unit and transferring the high density developing solutions to the developing devices therethrough,
wherein the high density developing solutions inside the ink cartridges are supplied directly to the developing devices through the cartridge unit and the connecting units, respectively.

2. The system according to claim 1, wherein each connecting unit comprises:
a tube.

3. A system for supplying a developing solution in an image forming apparatus, the system comprising:
ink cartridges containing corresponding ones of high density developing solutions having. respective colors and each having an ink density equal to or greater than 3%;
a cartridge unit receiving the ink cartridges and supplied with the high density developing solutions; and
developing devices developing an image using the high density developing solutions supplied from the cartridge unit.

4 The system according to claim 3, further comprising:
a connecting unit connecting the cartridge unit to the developing devices to transfer the high density developing solutions to the developing devices therethrough.

5. The system according to claim 4, wherein the connecting unit comprises:
a plurality of tubes coupled between the cartridge unit to respectively ones of the developing devices.

6. The system according to claim 4, wherein the connecting unit transfers the high density developing solutions from the cartridge unit to the developing devices without diluting the high density developing solutions

7. The system according to claim 4, wherein the connecting unit does not include ink tanks diluting the high density developing solutions with a solvent.

8. The system according to claim 4, wherein the connecting unit does not include a working solution unit mixing high density developing solutions with a solvent to produce a low toner density developing solution having another ink density lower than the ink density of the high density developing solutions.

9. The system according to claim 4, wherein the connecting unit does not include a norpar tank containing a solvent.

10. The system according to claim 4, wherein the developing devices do not receive other solutions lower than the ink density of the high density developing solutions.
